(19) United States
(12) Patent Application Publication
(10) Pub. No.: US 2024/0340654 A1
(43) Pub. Date: Oct. 10, 2024

(54) SIDELINK INTER-USER EQUIPMENT COORDINATION (IUC) FOR BEAM MANAGEMENT IN RESOURCE SELECTION

(71) Applicant: Apple Inc., Cupertino, CA (US)

(72) Inventors: Huaning Niu, San Jose, CA (US); Dawei Zhang, Saratoga, CA (US); Wei Zeng, Saratoga, CA (US); Chunxuan Ye, San Diego, CA (US); Haitong Sun, Cupertino, CA (US); Weidong Yang, San Diego, CA (US)

(21) Appl. No.: 18/587,073

(22) Filed: Feb. 26, 2024

Related U.S. Application Data
(60) Provisional application No. 63/494,978, filed on Apr. 7, 2023.

(51) Int. Cl. H04W 16/28; H04B 17/318; H04W 72/02; H04W 72/25

(52) U.S. Cl. CPC H04W 16/28; H04B 17/328; H04W 72/02; H04W 72/25

(57) ABSTRACT

A user equipment (UE), a base station, a baseband processor or other network device can operate to perform an inter-UE coordination (IUC) operation for a sidelink (SL) communication by processing an IUC message that comprises at least one of: receiving UE sensing results associated with directional sensing or beam alignment SL control channel/sidelink data channel transmission information. The SL communication can then be transmitted based on resources selected in resource selection from the IUC.

### CROSS-REFERENCE TO RELATED APPLICATIONS

The application claims the benefit of U.S. Provisional Patent Application 63/494,978 filed Apr. 7, 2023, entitled “SIDELINK INTER-USER EQUIPMENT COORDINATION (IUC) FOR BEAM MANAGEMENT IN RESOURCE SELECTION”, the contents of which are herein incorporated by reference in their entirety.

### FIELD

The present disclosure is related to wireless technology and an inter-user equipment (IUE) coordination (IUE) for beam management in resource selection for sidelink (SL).

### BACKGROUND

As the number of mobile devices within wireless networks, and the demand for mobile data traffic, continue to increase, changes are made to system requirements and architectures to better address current and anticipated demands. For example, some wireless communication networks (e.g., fifth generation (5G) or new radio (NR) networks) may be developed to include UE to UE (U2U) relay communications or UE to network (NW) (U2N) relay communications. In such scenarios, path sidelink (SL) relay enhancements can be made.

### BRIEF DESCRIPTION OF THE DRAWINGS

FIG. 1 illustrates an example process flow of resource selection according to various aspects.

FIG. 2 illustrates an example of SL communication with directional transmission/receiving beam alignments according to various aspects.

FIG. 3 illustrates another example of SL communication with directional transmission/receiving beam alignments according to various aspects.

FIG. 4 illustrates an example of an inter-user equipment (UE) coordination (IUC) scheme for beam management in SL communication in accordance with various aspects.

FIG. 5 illustrates another example of an IUC scheme for beam management in SL communication in accordance with various aspects.

FIG. 6 illustrates an example of a signaling for SL communication in accordance with various aspects.

FIG. 7 illustrates another example of a signaling for SL communication in accordance with various aspects.

FIG. 8 illustrates an example of an IUC message for an IUC in SL transmission in accordance with various aspects.

FIG. 9 illustrates an example of a reactive IUC scheme 900 for beam management in accordance with various aspects.

FIG. 10 illustrates another example of an IUC scheme for beam management in SL communication with overlapping beams or wide beam in accordance with various aspects.

FIG. 11 illustrates another example of an IUC scheme for beam management in SL communication with different receiving beams in accordance with various aspects.

FIG. 12 is an example process flow or method for enhancing resource selection by an IUC scheme for beam management in SL communication.

FIG. 13 illustrates an exemplary block diagram illustrating an example of user equipment(s) (UEs) communicatively coupled a network with network components as peer devices useable in connection with various embodiments (aspects) described herein.

FIG. 14 illustrates an example simplified block diagram of a user equipment (UE) wireless communication device or other network device/component (e.g., base station, eNB, gNB) in accordance with various aspects.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Various aspects including a user equipment (UE) device enabling sidelink (SL) communication are described herein. A UE device can be a pedestrian UE (P-UE) device, a vehicle-to-everything (V2X) device, or other UE that may include vehicle-to-vehicle (V2V), vehicle-to-infrastructure (V2I), vehicle-to-pedestrian (V2P) device communication, or other UEs operating in a SL communication. A UE can also include a Roadside Unit (RSU), a drone, other vehicle device, Internet of Things (IoT) device, or other UE device, for example. Different types of communications are considered in new radio (NR) devices to fulfill requirements for vehicle networks, including operation in NR unlicensed (NR-U) networks. The use cases may involve different types of communication types on SL unlicensed (SL-U) communication channels.

Two different types of categories of SL communication are known based on the resource allocation method configured: mode 1 communication and mode 2 communication. Mode 1 communication includes a base station (e.g., gNB or eNB) allocating usable resources for direct communication between terminals (different UEs) and can be used when all terminals that perform SL communication are in an in-coverage situation. Mode 2 communication is a method where each UE or terminal selects usable resources for direct communication and can be used even when the terminals are in an out-of-coverage situation. Because the base station does not intervene in resource allocation for mode 2 communication, the UE identifies the usable resources itself. Sensing is used for identifying resources that can be used for the sidelink, in order to decode the physical sidelink control channel (PSCCH) during a sensing window of a certain period before performing the SL transmission.

Different potential beam alignment issues can arise when a transmitting UE and a receiving UE participate in SL communication, especially regarding frequency range 1 (FR1) and frequency range 2 (FR2) transmission in reception beam alignment. For example, in SL in FR1, various operations rely on omni-directional (omni) transmission/receiving such as with operations including sensing, resource selection, and resource reservation. The transmitter UE controls the SL transmission based on the sensing and resource selection results, while the receiving UE monitors resources in the configured resource pool to receive any transmission within this pool. However, with omni-directional transmission in FR1 a beam conflict can occur when the receiving UE is not capable of receiving the transmitting UE transmission or is in a transmission mode itself with a similar resource as the transmitting UE (referred to as a half-duplex issue). Alternatively, or additionally, the receiving UE could have a high reference signal received power (RSRP) for a particular resource unbeknown to the transmitting UE, which may not be reflected during resource selection by the transmitting UE. In this case, the transmitting UE may select SL resources without regard to the receiving UE.

In contrast, in SL FR2 transmission, when directional transmission/receiving is utilized between the UEs in SL the issues discussed above can be more serious and compounded with other issues. Because the receiving UE in an omni-directional receiving monitors all resources in the configured resource pool to receive the transmission within this pool, a lack of sensing results or a hidden node interfering is not as much an issue as it can be with FR2 transmission for mode 2 in SL. The SL resource selection procedure does not adequate reflect the receiver UE conditions. For example, if the transmitting UE RSRP is good, this condition is not necessarily reflected directly to the receiver UE side of the RSRP measurement. Thus, resources may not be selected without having a high chance of collision or that are infeasible for the receiver UE. In addition, the half-duplex issue remains present in cases involved FR2 for mode 2 in SL, where the transmitting UE may reserve a resource regardless of whether the receiving UE is monitoring or capable of receiving the resource (e.g., the receiving UE may be transmitting on the same resource to a different UE).

In an aspect, an inter-UE coordination (IUC) for a SL communication can be generated from the receiving UE's perspective and used for resource selection by the transmitting UE side. An IUE can be performed for SL communication by configuring an IUC message with receiving UE sensing results associated with directional sensing. The receiving UE sensing results can include any slots that have a reference signal received power (RSRP) above an RSRP threshold for a receiving beam, such as with slot indices where receiving beams are directed to the UE.

Additionally, or alternatively, the IUC message can include beam alignment SL control channel/SL data channel transmission information. This information can include any SL resources or slots reserved by one or more other SL transmissions associated with the receiving UE in a transmitter/receiver UE pair. In this manner, the transmitting UE would not necessarily select resources with a lack of sensing results so that candidates that appear to be good candidate resources may not be for the receiving UE, or candidates that appear to not be good at the transmitting UE may be good resource candidates at the receiving UE.

Additionally, or alternatively, the IUC message can further include information related to a receiving UE transmission mode to determine whether a resource of the receiving UE sensing results is being used for transmission or in a transmission mode. Thus, the IUC can be configured by the receiving UE to also resolve the half-duplex issue.

The aspects within this disclosure can be particularly beneficial in the application of SL FR2 IUC for beam management in resource selection mode 2, but are not necessarily limited thereto and could be implemented in the application of SL FR1 for beam management as well. Additional aspects and details of the disclosure are further described below with reference to figures.

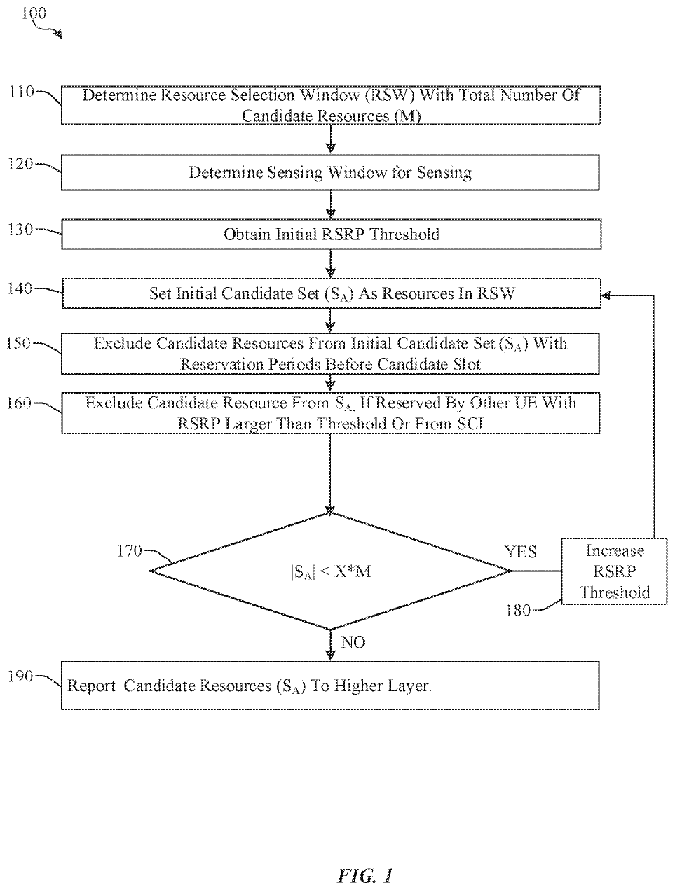

FIG. 1 illustrates an example process flow 100 for a resource selection procedure for mode 2 SL communication that includes identifying candidate resources by a UE autonomously in accord with various aspects.

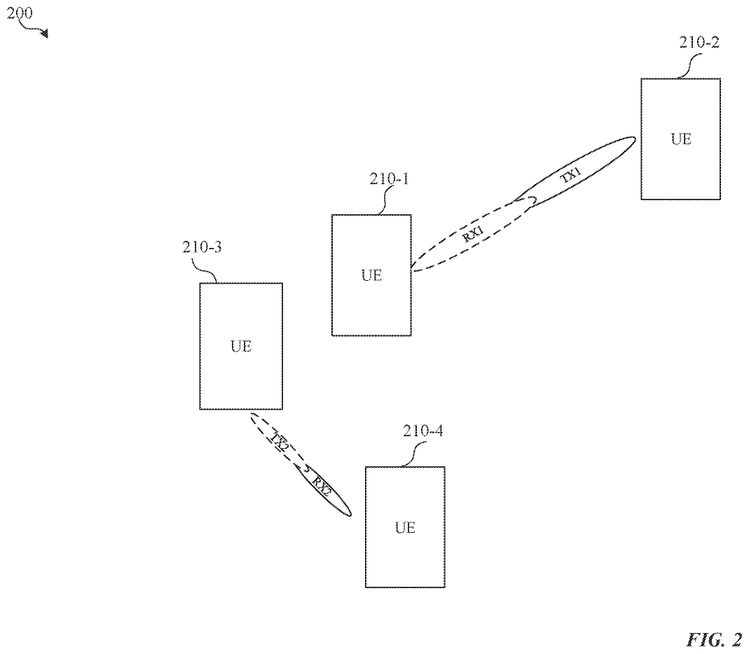

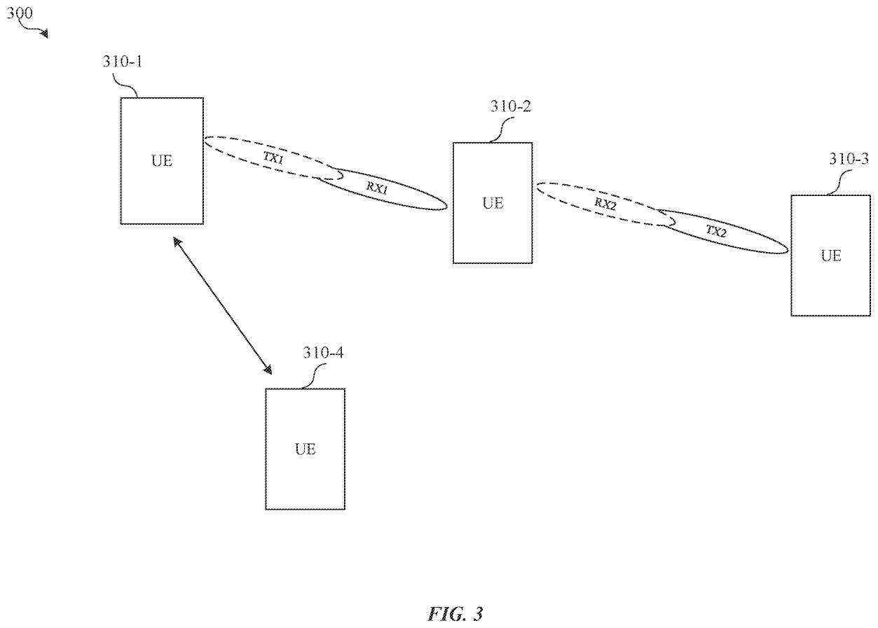

The method initiates at 110 with determining a resource selection window (RSW) based on a total number of sidelink candidate resources (M) within a period, a timed window, or a time of potential candidate resources. The PHY layer of the transmitting UE (e.g., 210-1 of FIG. 2 or 3) determines the parameters of the RSW, and the total number of the candidate resources in this window, which can be denoted as M. The RSW can be denoted as [n+T1, n+T2], where n can be a time of the resource selection slot, and T1 the beginning slot time offset and T2 the ending slot time offset of the RSW.

At 120, the method 100 continues with determining a sensing window [n−T₀, n−T_{proc,0}] sensing for sensing of any candidate resources to be used for the mode 2 SL communication, where T_{proc,0} includes a processing time of sensing results. The sensing window is configured for sensing before the RSW such as to decode a PSCCH, and can be a partial sensing window or full sensing window, for example.

At 130, an initial reference signal received power (RSRP) threshold can be obtained. The sensing window is used to monitor resources from other UEs as well as perform S-RSSI/RSRP measurements to select the most suitable resources within a selection window, for example, for use in SL communication.

At 140, an initial candidate resource set (S_{A}) is selected according to the RSRP threshold based on the RSW. Here, all the resources within the timed RSW can be set as a candidate resource set/set of candidate resources, denoted as S_{A}, or referred to as the initial candidate set as all resources in the RSW.

At 150, the candidate slot resources can be excluded from the initial candidate resource set S_{A} if these slots are not being monitored by the UE 210-1.

At 160, if the UE 110-1 detects that some resources have been reserved by another UE by performing sensing operations, the UE 110-1 can exclude those reserved resources from the initial resource set S_{A}, especially by another UE with an RSRP threshold that is larger than the RSRP threshold used for the resource selection process flow. Transmissions that are received by the UE 110-1 can occupy resources, which are periodically allocated and can be projected onto some resources within the UE (re) selection window (n). Thus, because the UE knows these resources are already occupied by its reception of these transmission, the transmitting UE 110-1 can operate to exclude these resources from a resource candidate set.

The condition for iteration of another round of resource sensing/exclusion/modification of the initial candidate set to ensure satisfaction of the threshold can be defined by decision 170. The condition(s) can include whether the initial candidate resource set S_{A} is less than a reported portion (X) of the total (M) number of sidelink candidate resources (|S_{A}|<X*M). If the condition is satisfied as “Yes”, then the process flows to 180 for increasing or modifying the RSRP threshold. If any of these conditions are not satisfied, then the process flows to 190 for reporting the data in SL communication from the PHY layer to a higher layer (e.g., a MAC layer).

In response to a condition being satisfied, another iteration of the resource selection procedure can be performed by modifying the RSRP threshold at 180, re-selecting the initial candidate resource set based on the RSW and excluding the unavailable candidate resources. If the remaining resources in the initial candidate set or set of candidate resources S_{A} is less than a certain percentage or reported portion X times the total number of candidate resources M, another iteration of a loop in the resource selection procedure can be performed again because there are too few candidate slots for transmission; otherwise, the UE reports the resources to the higher layer from a PHY layer. At 180, a 3 dB adjustment, for example, or other adjustment amount of priority dependent reference signal received power (RSRP) thresholds can be reused to reselect the candidate resource set of the predefined size.

Thus, the decision box 170 has the condition |S_{A}|<X*M. As stated above, M is the total number of candidate resources and X is a required number or percentage of the reported resources. If the conditions is not satisfied, then there are enough candidate resources and reporting at 190 can occur without additional iteration. Then at 190, the set S_{A} can be reported to a higher layer.

The process flow 100 is optimized for periodic traffic for resource selection, but does not necessarily take into account sensing result from the receiving UE, especially by addressing issues that are more serious in FR2 and mode 2 SL communication. The process flow 100 is primarily from a transmitter UE perspective. Thus, despite whether an RSRP satisfies a predetermined threshold for a resource at the transmitter UE, the same may not hold true at the receiver UE. In particular, the same resource may have less or greater interference/RSRP at the receiving UE. Another terminal or UE may be interfering or not at the particular resource for the receiving UE, while the opposite scenario is sensed at the transmitting UE. The half-duplex issue also remains.

In an aspect, the IUC process/scheme for a SL communication can be generated by transmitting an IUC message proactively in a proactive IUC scheme or reactively in a reactive IUC scheme to help the transmitting UE in resource selection. A proactive IUC can include coordination information of the IUC message that includes a set of preferred resources as well as a set of non-preferred resources of the receiving UE. Non-preferred resources could be those resources that may be in conflict with the receiving UEs resources or have an RSRP measurement exceeding an RSRP threshold. Alternatively, or additionally, a reactive IUC can include coordination information of the IUC message that includes the presence of expected/potential resource conflicts on resources, which can be indicated by an SCI.

FIG. 2 illustrates an example of SL communication 200 with directional transmission/receiving beam alignments. Directional transmission/receiving can be performed with a narrow beam directed in one particular angle or direction rather than many directions or angles as with omni-directional transmission/reception. In contrast, omni-transmission and receiving may be performed in a lower frequency FR1 sidelink communication, or when beamforming is not performed. In FIG. 2, UEs 210-1 and 210-2 are configured as a first unicast pair and UEs 210-3 and 210-4 are configured as a second unicast pair, each referred to as transmitter/receiver UE pairs or unicast pairs.

During configuration as a unicast pair, UEs 210-1 and 210-2 select beams TX1 and RX1 for use in unicast communication between them. As disclosed above, a different TX/RX pair (not shown) may be selected for the unicast pair for transmission from UE 210-2 to UE 210-1. The second unicast pair, UEs 210-3 and 210-4, selects beams TX2 and RX2 for use in unicast communication between them.

SL communication that supports beamforming is a major aspect of NR communication in high frequency bands (e.g., FR2). In SL beamforming, pairs of UEs that are being configured for transmission/reception as unicast pairs for SL communication may perform a link set up procedure to select transmit (TX) and receiver (RX) beams for use in directional sidelink communication. When a unicast pair selects TX and RX beams, if a UE in the pair supports beam correspondence then the UE may use the same beam for transmitting to and receiving from the other UE in the unicast pair. If the UE does not support beam correspondence, then separate TX and RX beams are selected for use in sidelink communication with the other UE in the unicast pair. Thus, after an SL channel is established, there may be a single TX/RX beam pair used for communication in the unicast pair, or there may be two TX/RX beam pairs, with one pair for each direction of transmission.

When a UE is configured in multiple unicast pairs, the UE may select different beams for use in SL communication with different UEs. When a receiving beam is in one slot only one set of receiving beams are utilized by the receiving UE 210-1. After an SL link is established, the UEs may perform measurements and beam re-selection for each unicast pair that they belong to. In mode 2, the transmitter UE 210-2 can autonomously determine SL transmission resources by sensing and resource selection. However, resources may be selected that have a high chance of collision or are infeasible for the receiver UE 210-1, especially when the resource selection procedure (e.g., process flow 100 of FIG. 1) does not take into account the receiver UE sensing results, where a lack of sensing results or hidden node issue may result in an inadequate or inefficient resource selection for SL communication. Sensing results taking into account RSRP measurements at the receiving antennas, or taking into account resources affected by another node (Tx/Rx UE pair) causing interference as a hidden node issue could fail to be taken into account at resource selection by the transmitting UE.

In an example, UE 210-3 may sense the transmission from the transmitting UE 210-2 to the receiving UE 210-1. However, the transmission UE 210-3 transmitting to the receiving UE 210-4 may not impact the reception of UE 210-1. The sensing results of the transmitting UE 210-2 thus would not necessarily take into account the interference conditions in a Tx/Rx beamformed UE pair with the reception of the receiving UE 210-1.

Additionally, the receiver UE 210-1 should know the receiving beam. If multiple UEs are transmitting, the UE 210-1 may miss the transmission due to a reception beam misalignment. As such, a lack of sensing results can be more severe in the case of FR2, where directional transmission/receiving is operational for SL communication. The transmitter UE interference RSRP does not necessarily correlate with the receiving RSRP measurements in sensing. Thus, in this example the UE 210-2 transmits on resources that are not impacted by the UE 210-3 transmission to UE 210-4. Additionally, the UE 210-3 when doing resource selection based on RSRP sensing may see this resource slot as having a high interference when actually the receiving UE 210-4 may have a clear channel so that even if the transmitting UE 2-3-4 transits to this direction, the receiving UE 210-4 would still not be impacted by the UE 210-1 and UE 210-2 Tx/Rx UE pair.

FIG. 3 illustrates an example of SL communication in which directional (e.g., beamformed) transmission and receiving are used with a potential beam conflict. Additionally, or alternatively to the situation to FIG. 2, the half-duplex issue may be present among these UEs where the receiving US could be transmitting on a same resource, or, otherwise not capable of receiving SL communication on a particular resource. For example, the receiving UE could be in a transmission mode not able to receive a transmission on the same resource, for example.

In FIG. 3, UEs 310-1 and 310-2 are configured as a first unicast pair and UEs 310-2 and 310-3 are configured as a second unicast pair (or, Tx/Rx UE pair). UEs 310-1 and 310-4 are another unicast pair such that UE 310-1 is configured in multiple transmitter/receiver UE pairs (or, unicast pairs). During configuration as a unicast pair, UEs 310-1 and 310-2 select beams TX1 and RX1 for use in unicast communication between them, for example. The second unicast pair, UEs 310-2 and 310-3, selects beams TX2 and RX2 for use in unicast communication between them. In the illustrated SL communication, UE 310-2 is tuned to receive on beam RX1 while UE 310-3 is transmitting a unicast transmission to UE 310-2 using beam TX2. Thus, in FR2, if UE 310-1 is transmitting and UE 310-1 is transmitting, then UE 310-2 has to point the receiving beam at either UE1 or UE3. Additionally, if UE 310-1 and 310-3 are transmitting in the same slot, the UE 310-2 has to determine which receiving UE beam to use. This can result in a potential beam conflict as well as the half-duplex issue where the UE may or may not be capable of reception, for example.

In an aspect, an IUC scheme can include an ICU message with information that includes one or more of: receiving UE sensing results associated with directional sensing, information related to the half-duplex issue (e.g., a receiving UE transmission mode or a receiving mode for any particular resource), or beam alignment SL control channel/sidelink data channel transmission information. For example, the receiving UE (e.g., 310-2) sensing results can include indication(s) of any slots that have an RSRP satisfying an RSRP threshold for a receiving beam, including one or more slot indexes where receiving beams are directed to the transmitting UE (e.g., 310-1 or 310-3).

Additionally, or alternatively, the beam alignment SL control channel/sidelink data channel transmission information of the IUC message comprises any SL resource(s) or slot(s) reserved by one or more other SL transmissions associated with the receiving UE in a transmitter/receiver UE pair. Thus, the IUC information of an IUC message can include resources reserved by transmitting UE 310-1 that is communicated to the other transmitting UE 310-3, and vice versa, in which the IUC message from UE 310-2 to the transmitting UE 310-1 includes resources reserved by transmitting UE 310-3.

Presuming that the FR2 beam is acquired, the receiving UE (e.g., UE 310-2 of FIG. 3) can configure resources in the IUC messages for UE pairs to know which slots or resources to use or which beam to transmit and receive according to a proactive IUC scheme or a reactive IUC scheme. The proactive IUC message can include a set of preferred resources as well as a set of non-preferred resources of the receiving UE to assist the transmitting UE in resource selection. The proactive IUC message can include slot indices where receiver beams are directed to/pointing to the transmitting UE. Non-preferred resources could be those resources that may be in conflict with the receiving UEs resources or have an RSRP measurement exceeding an RSRP threshold. The proactive IUC scheme can include an explicit request based IUC or a non-explicit request based IUC depending on whether an explicit request for IUC message information from the transmitting UE is communicated to the receiving UE.

Alternatively, or additionally, a reactive IUC can include indication(s) of expected/potential resource conflicts on any resources of a resource pool, which can be indicated by an SCI. For example, the reactive IUC message can be based on reserved slot information from a transmitting UE (e.g., 310-1 or 310-3) in SCI or sensed. The receiving UE 310-2, for example, can provide ICU information back to the transmitting UE (e.g., 310-1 or 310-3) with indication(s) to which resources/slots have a receiving beam conflict, based on the reserved slot information or not.

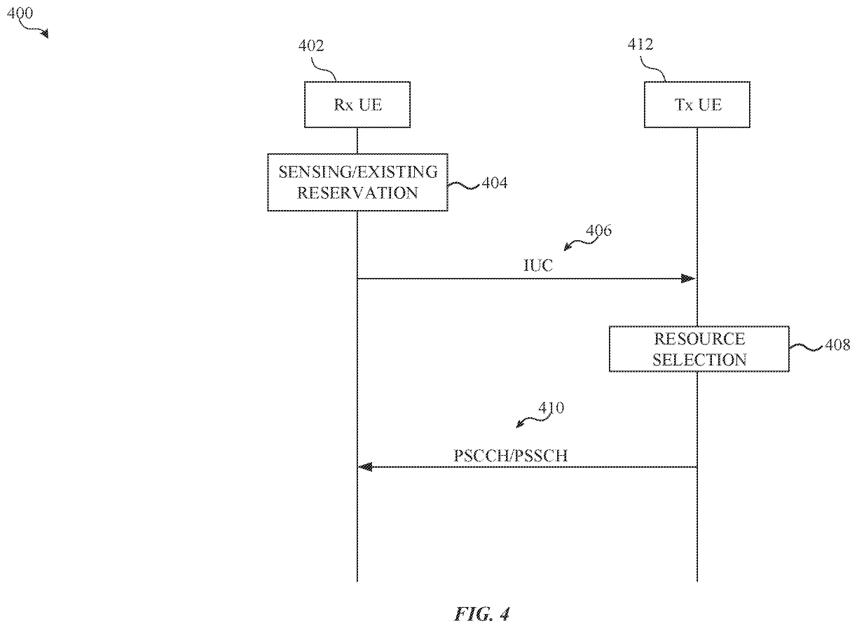

FIG. 4 illustrates an example proactive IUC scheme 400 for beam management as discussed according the aspects herein. The IUC scheme 400 can comprise a non-explicit request based IUC as a proactive IUC scheme that is without any explicit request for an IUC message from a transmitting UE 412. A receiving UE 402 initiates sensing on its own to sense any existing resources or reservations. This sensing can be based on reservations of an SCI received from the transmitting UE 412, an initiation to enter into SL communications with the transmitting UE or other trigger. Without the transmitting UE 412 communicating a request for an IUC message, the UE 402 senses at 404 resources by measuring RSRP measurements for potential receiving/reception beams or corresponding transmission beams. Additionally, the UE 402 can further determine any resource reservations associated with any resources of a resource pool for the receiving UE 402 as a part of the sensing operations at 404.

Upon obtaining sensing information related to resources associated with the UE 402 any reservations, the UE 402 can transmit the IUC message 406 with such information to the transmitting UE 404. The IUC message 406 can include preferred resources as and non-preferred resources of the receiving UE 402 to assist the transmitting UE 404 in resource selection. The proactive IUC message 406 can include slot indices where receiver beams are directed to/pointing to the transmitting UE. Non-preferred resources can include those resources that may be in conflict with the receiving UEs resources or have an RSRP measurement exceeding an RSRP threshold.

The ICU message 406 can include receiving UE sensing results associated with directional sensing. Such receiving UE sensing results can include indication(s) of any slots that have an RSRP satisfying an RSRP threshold for a receiving beam, include one or more slot indexes where receiving beams are directed to the transmitting UE, which can be classified as non-preferred to be excluded. Those resources below the RSRP threshold could be without significant interference and indicated as preferred, for example.

The IUC message 406 can also include information related to the half-duplex issue (e.g., indications of a receiving UE transmission mode or a receiving mode for any particular receiving resource), as well as beam alignment SL control channel/sidelink data channel transmission information. The beam alignment SL control channel/sidelink data channel transmission information can include any SL resource(s) or slot(s) reserved by one or more other SL transmissions associated with the receiving UE in a transmitter/receiver UE pair that may be using a different beam.

Where multiple unicast pairs are associated with the receiving UE 402, information associated with setting preferred/non-preferred slot patterns between the different transmitting UEs associated or communicating with the UE 402 can also be indicated for facilitating SL communication between the different transmitting UEs. The slot patterns indicated can be based on a traffic priority among the data of the transmitting UEs, their associated RSRPs in transmission, or a round-robin sharing scheme based on the same (e.g., traffic priority, RSRP, or a priority of the UEs themselves).

In an aspect, the IUC message can be in a container or encapsulated. For example, the IUC message can be contained or configured within an IUC medium access control (MAC) control element (MAC CE) or a SCI stage 2. For example, the IUC MAC CE can be multiplexed or piggybacked with a latest or most current physical SL shared channel (PSSCH) from the receiving UE 402 to the transmitting UE 404, for example.

At 408, the transmitting UE 404 then performs resource selection with acts or operations similar to process flow 100 of FIG. 1 but while taking into account or factoring the selection of resources based on the IUC information of the IUC message 406, and thus, making resource selection more accurate and efficient for SL communication in FR 2 mode 2 SL.

At 410, the transmitting UE 404 transmits a physical sidelink control channel (PSCCH)/PSSCH for an SL communication over an SL channel with the resources selected at 408.

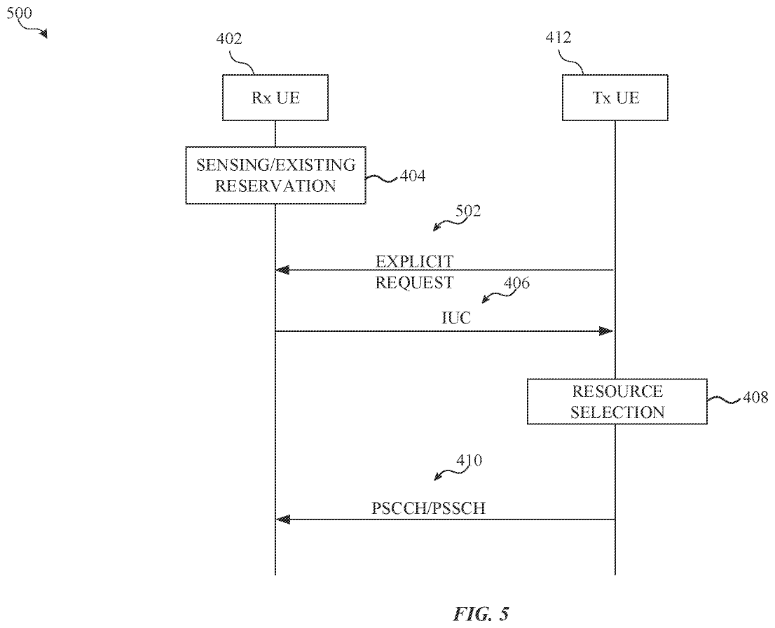

FIG. 5 illustrates an example proactive IUC scheme 500 for beam management as discussed according the aspects herein. The IUC scheme 500 can include an explicit request based IUC as a proactive IUC scheme, in which the transmitting UE 412 transmits an explicit request for an IUC message from a transmitting UE 412 via one or more data fields or indications in a data channel or control channel. For example, the explicit request 402 can be transmitted by the transmitting UE 412 initiating SL communication with the receiving UE 402. The request 402 can be multiplexed or piggybacked with a latest or most current PSSCH transmission from the transmitting UE 412 to the receiving UE 402.

The actions of the process flow or IUC 500 are similar to the process flow 400 of FIG. 4. However, the receiving UE 402 responds to the explicit request by sensing existing resources/reservations, which can be performed before or after receiving the explicit request. Then, the receiving UE 402 transmits the IUC message in response to the request 502 as a part of the proactive IUC scheme as an explicit request based IUC.

In an aspect, the IUC 406 can be transmitted after a configured offset from or indicated by the request 502. In this manner, the receiving UE 402 and transmitting UE 412 can be aware of the Tx/Rx beam to receive the IUC message. For example, if the request 502 is send on a slot N, the IUC 406 can be sent on a slot N plus an offset (N+offset). The request message can indicate the offset either as the trigger for the IUC message or along with a request field or indication for the IUC in the request message 502, for example.

Upon receiving the IUC 406, the transmitting UE 412 in turn performs resource selection 408 based on the IUC message information of the IUC message 406, as discussed above and uses the selected resources to effectively perform SL transmission to the receiving UE 402 via the PSCCH/PSSCH 410.

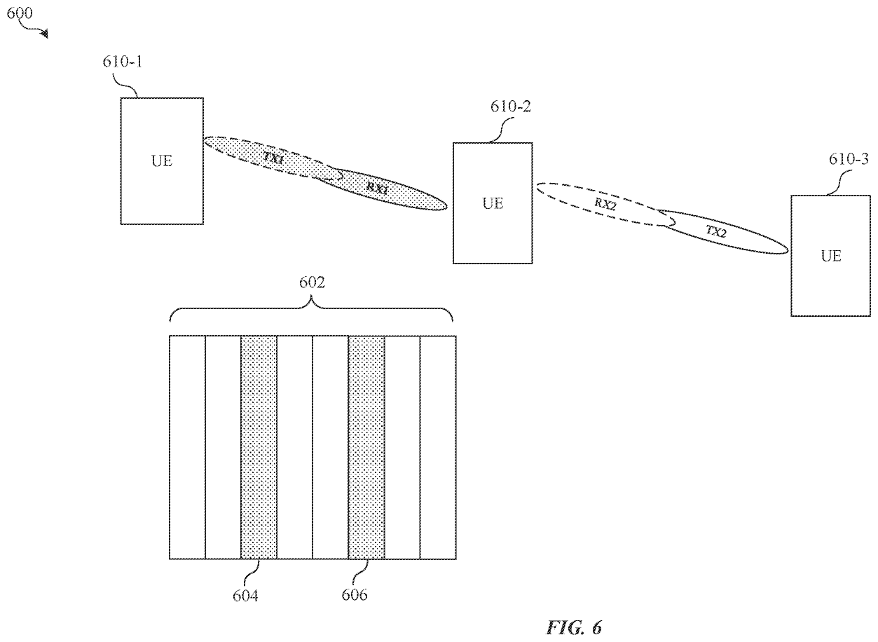

FIG. 6 illustrates an example of an IUC message transmission 600 that can include Tx/Rx beam alignment PSCCH/PSSCH transmission information for a transmitting UE (e.g., UE 610-3) to determine preferred/non-preferred resources of a receiving UE 610-2 in a unicast pair. The receiving UE (e.g., UE 610-2) can provide an IUC message 602, for example, that includes beam alignment SL control channel/sidelink data channel transmission information. This information can include any SL resource(s) or slot(s) reserved by one or more other SL transmissions associated with the receiving UE in a transmitter/receiver UE pair that may be using a different beam. The receiving UE 610-2 can configure the IUC message 602 based on one or more criteria, including whether the slots have been reserved by another SL transmission with respect to the receiving UE 610-2 using a different beam, or whether the slots have high RSRP when measured using an Rx beam corresponding to a transmitting UE or transmitting beam.

The first criteria that includes slot reservations in the IUC can resolve any potential beam conflict if the slot had been reserved for transmission using a different beam, in which case then the receiving UE 610-2 would not be able to receive anything from the transmitting UE (e.g., 610-1 or 610-3) on that particular beam. This includes the Tx/Rx beam alignment PSCCH/PSSCH transmission information in the IUC message from the receiving UE 610-2 to one or more transmitting UEs 610-1 or 610-3.

In one example, the IUC message 602 from the receiving UE 610-2 being sent to transmitting UE 610-3 can exclude the resources reserved 604 and 606 as transmitting UE 610-1 to receiving UE 610-2 reserved slot(s) 604 and 606. Because the UE 610-2 has indicated which slots are reserved or are excluded in the IUC message to the UE 610-3, the transmitting UE 610-3 can selected resources based on the IUC message information for SL communication with the receiving UE 610-2 without interference. Additionally, the receiving UE can know the reception beams to monitor for SL transmission.

In an aspect, the UE 610-2 can operate to further configure a coordination between different unicast pairs (e.g., Tx/Rx UE pair 610-1 and 610-2 and 610-3 and 610-2). The coordination can include setting preferred/non-preferred slot patterns that are different for each transmitting UE so as to not collide. The transmitting UE can then select the resources from its own pool that correspond with the receiving UE resources in the IUC message or just based on the IUC message, for example, when configuring SL transmission in a resource selection window.

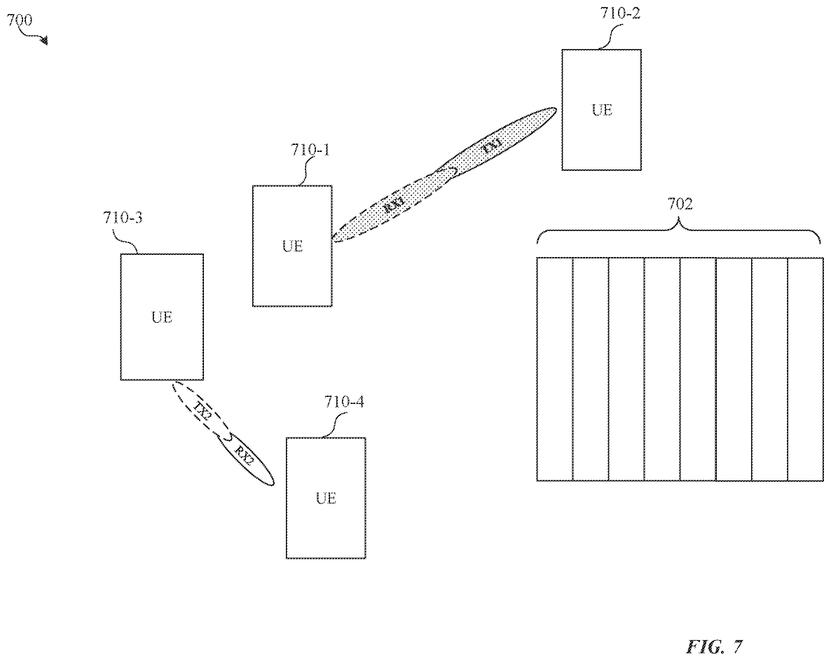

FIG. 7 illustrates an example of an IUC message transmission 600 that can include Tx/Rx beam alignment PSCCH/PSSCH transmission information for a transmitting UE (e.g., UE 710-3) to selected resources based on preferred/non-preferred resources of a receiving UE 610-2 as a unicast pair. The receiving UE 710-4, for example, can provide an IUC message 702 that includes receiving UE sensing results associated with directional sensing. The IUC message 702 can include information as to whether resources or slots have a high RSRP when measured using an Rx beam corresponding to a transmitting UE or transmitting beam.

The receiving UE 710-4 can configure an IUC message, for example, to the transmitting beam UE 710-3 without excluding slots or resources from another unicast pair such as UE 710-2 to UE 710-1 when measured as qualifying even when the transmitting UE 710-3 sensing does not view the beam at these resources as satisfying the RSRP threshold, or failing the RSRP threshold potentially as interference from UE 710-1 (or another other unicast pair with another beam). However, because the IUC message 702 indicates these same resources as viable, the transmitting UE 710-3 could use one of these beam resources successfully in SL transmission to the receiving UE 710-4 by resource selection based on the IUC message 702, despite its own sensing results.

Although FIG. 7 illustrates an example of an IUC message with information indicating whether the slots have high RSRP when measured using an Rx beam corresponding to a transmitting UE or transmitting beam, and FIG. 6 an example of beam alignment SL control channel/sidelink data channel transmission information. The IUC message information can include any SL resource(s) or slot(s) reserved by one or more other SL transmissions associated with the receiving UE in a transmitter/receiver UE pair that may be using a different beam, or that are being used by the receiving UE in transmission. The IUC message information can include one or more indications indicating whether slots or resources of the resource pool have been reserved by another SL transmission from the receiving UE's sensing using a different beam and whether the slots or resources have high RSRP when measured using a receiving beam corresponding to a transmitting UE or transmitting beam.

In an aspect, the receiving UE can operate to further configure a coordination between different unicast pairs. The coordination can include setting preferred/non-preferred slot patterns that are different for each transmitting UE when multi-unicast pairs are operating with a same UE. The transmitting UE can then select resources from its own pool that correspond with the receiving UE resources in the IUC message or just based on the IUC message, for example, when configuring SL transmission in a resource selection window.

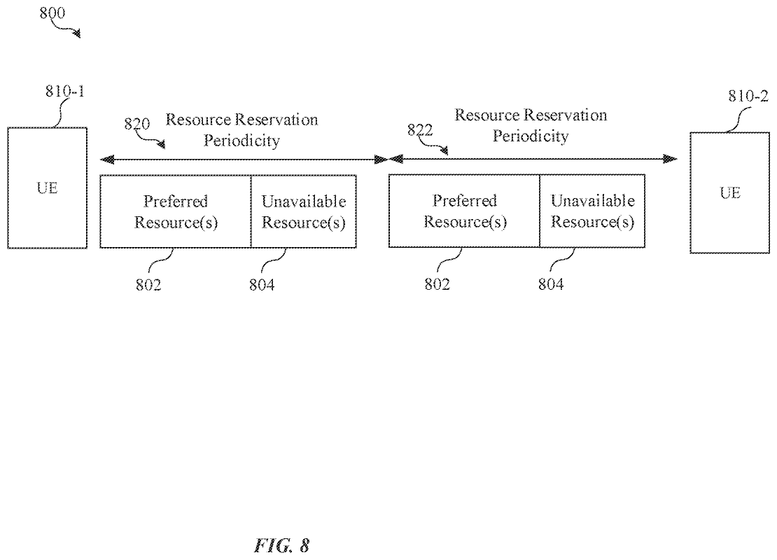

FIG. 8 illustrates an example of an IUC message 800 communicated from a receiving UE 810-1 to a transmitting UE 810-2. The IUC message 800 can include preferred resources 802 and non-preferred resources 804. As discussed above, the preferred resources can include resources that the receiving UE 810-1 can sense according to a sensing procedure in a sensing window, while excluding or indicating those resources that may not be directed to receiving from the transmitting UE 810-2, are reserved resources from another UE or Tx/Rx UE pair, or do not satisfy an RSRP threshold indicating an available resource in the non-preferred or unavailable resources 804 in the IUC message 800. The unavailable resources or non-preferred resources 804 may further include any resources that the receiving UE itself may be using such as in transmission or SL communication with another UE. Once UE 810-2 receives the IUC from UE-810-1, for example, UE 810-2 selects the resource based on the preferred and non-preferred resource indication.

In an aspect, the IUC message 800 includes preferred resource(s) 802 and non-preferred or unavailable resources 804. The IUC message 800 can be included in at least one of: an IUC medium access control (MAC) control element (MAC CE), an SCI stage 2 of SCI from the receiving UE, or both the MAC CE and the SCI stage 2 of SCI. For a lower number of bits, for example, the IUC message 800 an be communicated in the SCI stage 2, and if a higher number of bits are needed beyond a predetermined threshold the ICU message can be communicated as a part of or included in the MAC CE, depending on how much information is being shared between the two UEs 810-1, 810-2.

Additionally, or alternatively, the IUC message 800 can be received or transmitted over a reservation period or resource reservation periodicity 820 based on one or more resource periodicities 820, 822. The IUC message 800 can indicate the preferred/non-preferred resource(s) over a reservation period 820 or 822, if periodic reservation is enabled for a resource. Thus, the resource reservation periodicity 820 is an example of the resource reservation having a periodicity and then it can be applied to all the periodicities 820, 822 and so on as well. Thus, the IUC message information does not have to be a one shot, but can also be applied to multiple resource periodicities if periodic resources are used. In one example, multiple periodicities could be applicable to particular traffic such as Xr traffic (extended reality), other periodic data or resources, or the like.

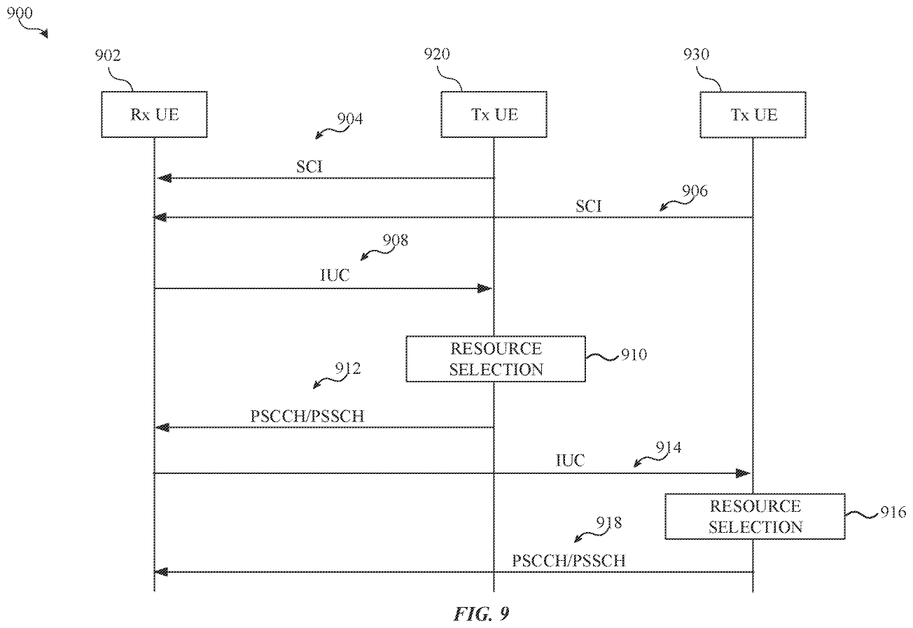

FIG. 9 illustrates an example of a reactive IUC scheme 900 for beam management. The IUC scheme 900 can include the receiving UE 902 receiving SCI 904 and 906 from one or more transmitting UEs 920 and 930. The SCI 904 and 906 can each include a reserved slot information from the transmitting UEs 920 and 930, respectively. In response to the SCI, receiving the corresponding reserved slot information of each transmitter/receiver UE pair (unicast pair), or other event/trigger, the receiving UE 902 can perform sensing operations for resources of a resource pool. The sensing operations can be based on the SCI or the reservation of one or more slots from the transmitting UE 920/930.

In response to receiving the SCI with the reserved slot information associated with the transmitting UE 920/930, for example, the receiving UE 902 transmits the IUC message 908/914 to the associated transmitting UE 920/930 with the information discussed herein, such as which slots have a receiving beam conflict or which slots would not have a receiving beam conflict based on the reservation information or SCI. Other IUC message information could also be included in the IUC message 908/914 such as slots that satisfy an RSRP threshold relative to receiving beams of the receiving UE 902 (e.g., receiving UE sensing results associated with directional sensing), which slots the receiving UE 902 may be using (e.g., for transmission or in a transmission mode for half-duplex issue resolution) and not capable of receiving on, beam alignment SL control channel/SL data channel transmission information (e.g., other slots reserved by other SL transmission using a different beam or associated with the UE (or not) in unicast pair), or other information. The IUC message 908/914 can further include one or more slot indexes where receiving beams are directed to the UE (transmitting UE).

In response to each of the transmitting UEs 920 and 930 receiving an associated IUC message 908/914 in an IUC (e.g., a MAC CE, SCI or other container), resource selection 910/916 can be performed based on the received IUC message 908/914 with data corresponding to and configured for each particular transmitting UE 920 and 930 according to corresponding sensing results from each Tx UE's SCI or reservation information. For example, the receiving UE 902 configures IUC 908/914 based on the reservation information corresponding to each transmitting UE 920 and 930, respectively, and based on other information such as RSRP measurements using a receiving beam corresponding to each transmitting UE 920 and 930, for example. The resource selection 908 is then based on the IUC 908/914 alone or additional sensing information at the transmitting UE.

In an aspect, the receiving UE 902 can be configured to be in control of resolution among transmitting UEs or in charge of resolving conflict between transmitting UE 920 and UE 930. If the SCI 904/906 sent from both transmitting UE 920 and UE 930 have a conflict with the receiving UE 902, the UE 902 can then resolve that conflict by sending the IUC information back to transmitting UE 920 and UE 930 indicating which slot can receive the transmission of UE 920 and which slot can receive the transmission of UE 930. Additionally, the UE 902 can indicate the receiving beam for UE 920 with the slots that have a higher and lower RSRP or not, as well as that for UE 930, which can differ from one another.

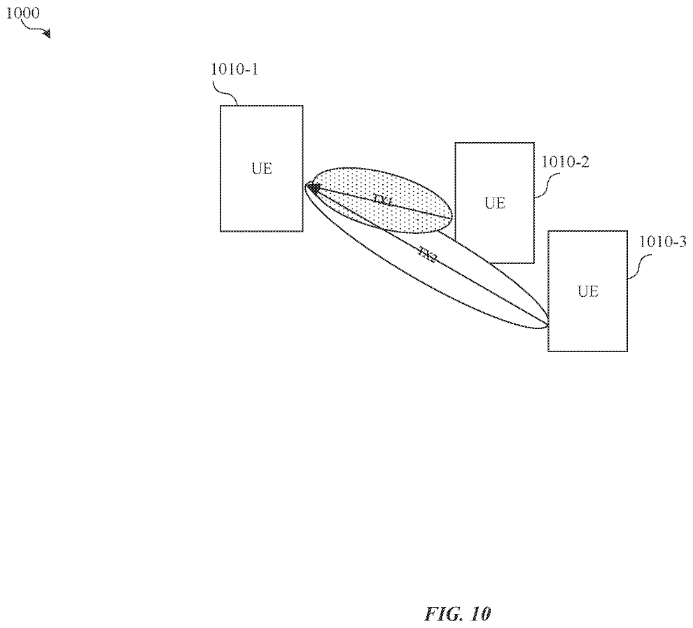

FIG. 10 illustrates an example of SL communications 1000 with a receiving UE 1010-1 having a wider-beam/similar beam to more than one transmitting UE 1010-2 and 1010-3. In response to the UE 1010-1 being associated with more than one transmitter/receiver UE pair (e.g., unicast pair 1010-1 and 1010-2 and unicast pair 1010-1 and 1010-3) on a same beam resource, for example, where wide beams overlap or similar beams are being utilized to the receiving UE 1010-1, the IUC message can be configured by the receiving UE 1010-1 to indicate resources based on an RSRP threshold, as well as be based on traffic priorities or delay budgets of the transmitter/receiver UE pairs.

In an aspect, the RSRP threshold can make a difference between these two unicast pairs while the priority of the traffic can be a factor for the receiving UE 1010-1 configuring and sending the IUC information as to which transmitting UE 1010-2 or 1010-3 may have a higher priority if there is some conflict in the reservation(s) of resources. For example, if UE 1010-2 has a higher traffic priority or a tighter delay budget, then receiving UE 1010-1 sends the IUC prioritizing the transmission of UE 1010-2. Alternatively, or additionally, if transmitting UE 1010-2 and 1010-3 has a same priority, then the UE with the higher RSRP could be prioritized.

Alternatively, or additionally, receiving UE 1010-1 could configure the IUC message in order to receive SL communication from UE 1010-2 and 1010-3 traffic in a round-robin way. For example, UE 1010-1 can enable UE 1010-2 and 1010-3 to know that one UE will receive its traffic in 1, 3 and 5 slots and then 2, 4, 6 slots for the other transmitting UE in a round robin operation. Thus, if transmitting UE 1010-2 and 1010-3 are in the same receiving beam direction various criteria can be utilized for configuring the IUC message, including RSRP, traffic priority, delay budget, a sharing or round-robin pattern, or the like that the receiving UE 1010-1 can use to resolve conflicts.

In an aspect, in response to the transmitter/receiver UE pairs being associated with a same priority, a receiver/transmitter UE pair with a higher RSRP among the plurality of transmitter/receiver UE pairs is prioritized for the resources or the IUC message indicates a round-robin allocation of the resources for the SL communication among the plurality of transmitter/receiver UE pairs.

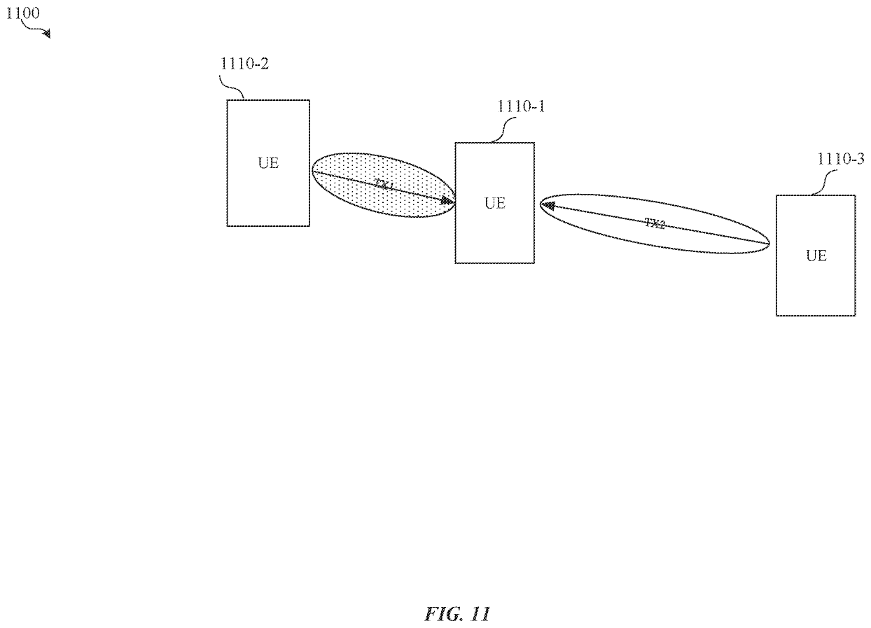

FIG. 11 illustrates an example of SL communications 1100 with a receiving UE 1110-1 having different receiving beams with more than one transmitting UE 1110-2 and 1110-3. Here, the receiving UE 1110-1 can utilize the IUC scheme for beam confliction based on traffic priority or just round-robin allocation if UE 1110-2 and 1110-3. The IUC message can be configured where there is a receiving beam conflict based on traffic priority among UE 1110-2 and 1110-3. If UE 1110-2 has higher priority, for example, the receiving UE 1110-1 can send the IUC message prioritizing the transmission of UE 1110-2, for example.

In an aspect, the IUC message can be in a container or encapsulated. For example, the IUC message can be contained or configured within a physical sidelink feedback channel (PSFCH). The PSFCH occasion can be mapped through an SCI transmission, for example. In response to different receiving UE beams corresponding to different transmitting UE transmissions (e.g., UE 1110-2 and 1110-3), the PSFCH can be transmitted through different beams, in different slots. The indices of these resources can be mapped to the PSFCH transmission start mapped through the index of resources of the PSSCH transmission. Thus, the index of resource PSFCH can be derived from PSSCH transmission slot(s).

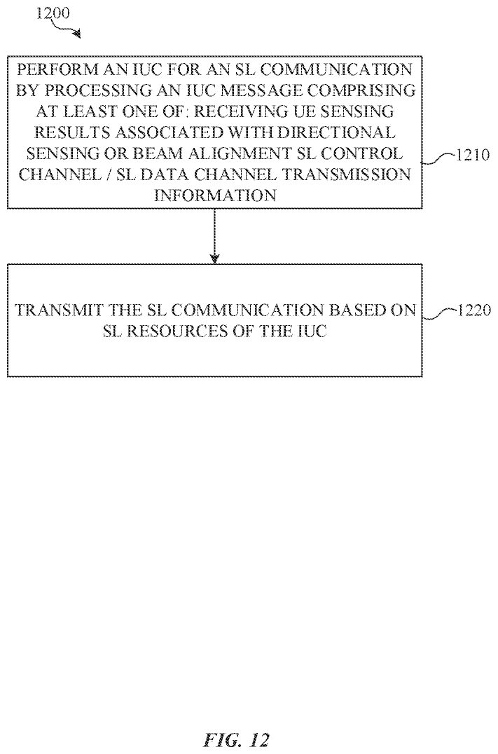

FIG. 12 illustrates an example process flow 1200 to enhance resource selection for SL communication in FR2 in mode 2 in accord with various aspects. The process flow 1200 initiates at 1210 with performing an IUC for a SL communication by processing an IUC message comprising at least one of: receiving UE sensing results associated with directional sensing or beam alignment SL control channel (PSCCH)/SL data channel (PSSCH) transmission information. In particular, when the UE is a receiving UE, the IUC message can be generated to assist a transmitting UE to select resources by taking into account conditions at the receiving UE's receiving beams. When the UE is a transmitting UE, the IUC message can be received and used for selection of resources for SL transmission to the receiving UE in a unicast SL pair.

At 1220, the process flow 1200 includes transmitting the SL communication based on SL resources selected by the IUC.

The process flow 1200 can further include receiving or transmitting in a proactive IUC scheme the IUC message comprising at least one of: a set of preferred resources, or a set of non-preferred resources, to assist in a resource selection, in response to a request for IUC coordination information, or without any request. The UE can operate in coordinating different SL communications among different unicast transmitter/receiver UE pairs by generating a preferred resource/non-preferred resource slot pattern among the different unicast transmitter/receiver UE pairs. The resources in the IUC message can be sent once or periodically on resources with a periodicity, for example.

In response to being communicatively coupled with a plurality of SL transmitter/receiver UE pair via different receiver beams conflicting, respectively, the IUC message can indicate resources for a SL transmitter/receiver UE pair based on at least one of: a traffic priority, a UE priority or a round-robin allocation of the resources for the SL communication among the plurality of transmitter/receiver UE pairs.

The process flow 1200 can include processing the IUC message in a PSFCH that is mapped through an SCI). When different beams are being associated with different SL transmitter/receiver UE pairs, the receiving UE can transmit the PSFCH with the IUC message through the different beams in different slots. An index of PSFCH resources can be derived from or based on one or more PSSCH slots.

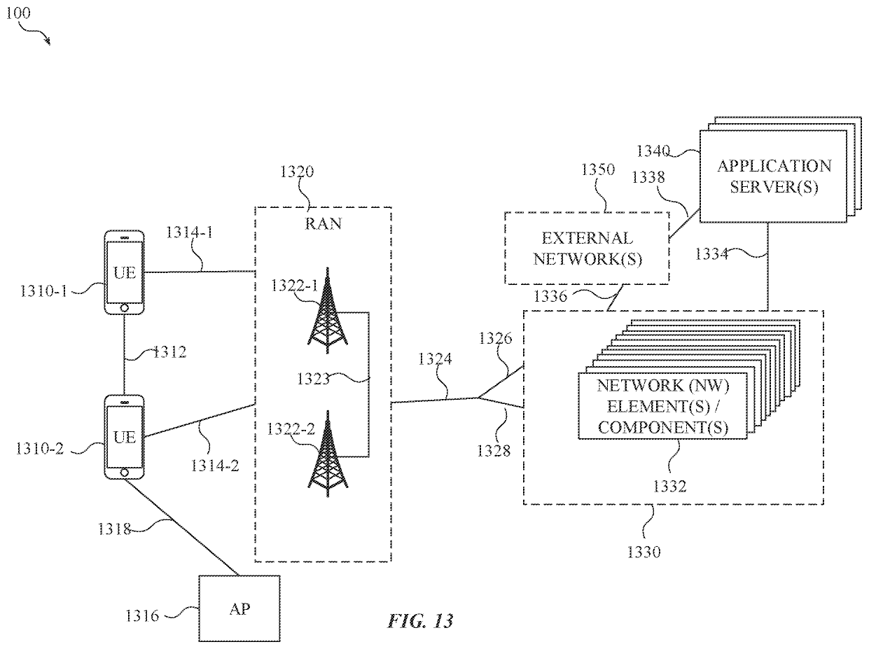

FIG. 13 is an example network 1300 according to one or more implementations described herein. Example network 1300 can include UEs 1310-1, 1310-2, etc. (referred to collectively as “UEs 1310” and individually as “UE 1310”), a radio access network (RAN) 1320, a core network (CN) 1330, application servers 1340, and external networks 1350.

UEs 1310 can communicate and establish a connection with (be communicatively coupled to) RAN 1320, which can involve one or more wireless channels 1314-1 and 1314-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes or base stations 1322 (e.g., 1322-1 and 1322-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 1330. Additionally, at least one of the MN or the SN can be operated with shared spectrum channel access, and functions specified for UE 1310 can be used for an integrated access and backhaul mobile termination (IAB-MT). Similar for UE 1310, the IAB-MT can access the network using either one network node or using two different nodes with enhanced dual connectivity (EN-DC) architectures, new radio dual connectivity (NR-DC) architectures, or other direct connectivity such as an SL communication channel as an SL interface 112.

In some implementations, a base station (as described herein) can be an example of network node 1322. As shown, UE 1310 can additionally, or alternatively, connect to access point (AP) 1316 via connection interface 1318, which can include an air interface enabling UE 1310 to communicatively couple with AP 1316. AP 1316 can comprise a wireless local area network (WLAN), WLAN node, WLAN termination point, etc. The connection 1318 can comprise a local wireless connection, such as a connection consistent with any IEEE 702.11 protocol, and AP 1316 can comprise a wireless fidelity (Wi-Fi®) router or other AP. AP 1316 could be also connected to another network (e.g., the Internet) without connecting to RAN 1320 or CN 1330.

RAN 1320 can also include one or more RAN nodes 1322-1 and 1322-2 (referred to collectively as RAN nodes 1322, and individually as RAN node 1322) that enable channels 114-1 and 114-2 to be established between UEs 1310 and RAN 1320. RAN nodes 1322 can include network access points configured to provide radio baseband functions for data or voice connectivity between users and the network based on one or more of the communication technologies described herein (e.g., 2G, 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 1322 can include a roadside unit (RSU), a transmission reception point (TRxP or TRP), and one or more other types of ground stations (e.g., terrestrial access points). In some scenarios, RAN node 1322 can be a dedicated physical device, such as a macrocell base station, or a low power (LP) base station for providing femtocells, picocells or other like having smaller coverage areas, smaller user capacity, or higher bandwidth compared to macrocells. As described below, in some implementations, satellites 160 can operate as bases stations (e.g., RAN nodes 1322) with respect to UEs 1310. As such, references herein to a base station, RAN node 1322, etc., can involve implementations where the base station, RAN node 1322, etc., is a terrestrial network node and also to implementation where the base station, RAN node 1322, etc., is a non-terrestrial network node.

Some or all of RAN nodes 1322 can be implemented as one or more software entities running on server computers as part of a virtual network, which can be referred to as a centralized RAN (CRAN) or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 1322; a media access control (MAC)/physical (PHY) layer split wherein RRC, PDCP, radio link control (RLC), and MAC layers can be operated by the CRAN/vBBUP and the PHY layer can be operated by individual RAN nodes 1322; or a “lower PHY” split wherein RRC, PDCP, RLC, MAC layers and upper portions of the PHY layer can be operated by the CRAN/vBBUP and lower portions of the PHY layer can be operated by individual RAN nodes 1322. This virtualized framework can allow freed-up processor cores of RAN nodes 1322 to perform or execute other virtualized applications, for example.

In some implementations, an individual RAN node 1322 can represent individual gNB-distributed units (DUs) connected to a gNB-control unit (CU) via individual F1 interfaces. In such implementations, the gNB-DUs can include one or more remote radio heads or radio frequency (RF) front end modules (RFEMs), and the gNB-CU can be operated by a server (not shown) located in RAN 1320 or by a server pool (e.g., a group of servers configured to share resources) in a similar manner as the CRAN/vBBUP. Additionally, or alternatively, one or more of RAN nodes 1322 can be next generation eNBs (i.e., gNBs) that can provide evolved universal terrestrial radio access (E-UTRA) user plane and control plane protocol terminations toward UEs 1310, and that can be connected to a 5G core network (5GC) 1330 via a Next Generation (NG) interface 1324.

Any of the RAN nodes 1322 can terminate an air interface protocol and can be the first point of contact for UEs 1310. In some implementations, any of the RAN nodes 1322 can fulfill various logical functions for the RAN 1320 including, but not limited to, radio network controller (RNC) functions such as radio bearer management, uplink and downlink dynamic radio resource management and data packet scheduling, and mobility management. UEs 1310 can be configured to communicate using orthogonal frequency-division multiplexing (OFDM) communication signals with each other or with any of the RAN nodes 1322 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or SL communications), although the scope of such implementations cannot be limited in this regard. The OFDM signals can comprise a plurality of orthogonal subcarriers.

A physical downlink shared channel (PDSCH) can carry user data and higher layer signaling to UEs 1310. The physical downlink control channel (PDCCH) can carry information about the transport format and resource allocations related to the PDSCH channel, among other things. The PDCCH can also inform UEs 1310 about the transport format, resource allocation, and hybrid automatic repeat request (HARQ) information related to the uplink shared channel. Typically, downlink scheduling (e.g., assigning control and shared channel resource blocks to UE 1310-2 within a cell) can be performed at any of the RAN nodes 1322 based on channel quality information fed back from any of UEs 1310. The downlink resource assignment information can be sent on the PDCCH used for (e.g., assigned to) each of UEs 1310.

The PDCCH uses control channel elements (CCEs) to convey the control information, wherein a number of CCEs (e.g., 6 or other number) can consists of a resource element groups (REGs), where a REG is defined as a physical resource block (PRB) in an OFDM symbol. Before being mapped to resource elements, the PDCCH complex-valued symbols can first be organized into quadruplets, which can then be permuted using a sub-block interleaver for rate matching, for example. Each PDCCH can be transmitted using one or more of these CCEs, where each CCE can correspond to nine sets of four physical resource elements known as REGs. Four quadrature phase shift keying (QPSK) symbols can be mapped to each REG. The PDCCH can be transmitted using one or more CCEs, depending on the size of the DCI and the channel condition. There can be four or more different PDCCH formats with different numbers of CCEs (e.g., aggregation level, L=1, 2, 4, 8, or 16).

The RAN nodes 1322 may be configured to communicate with one another via interface 1323. In implementations where the system is an LTE system, interface 1323 may be an X2 interface. In LTE networks, X2 and S1 interface are defined as the interfaces between RAN nodes and between RAN and Core Network. 5G may operate in two modes as non-standalone and standalone mode. For non-standalone operation the specification defines the extension for S1 and X2 interfaces as for standalone operation as X2/Xn for the interface between RAN nodes 1322 and S1/NG for the interface 1324 between RAN 1320 and CN 1330. The interface 1324 may be defined between two or more RAN nodes 1322 (e.g., two or more eNBs/gNBs or a combination thereof) that connect to evolved packet core (EPC), the CN 1330, or between eNBs connecting to an EPC. In some implementations, the X2/Xn interface may include an X2/Xn user plane interface (X2-U/Xn-U) and an X2 control plane interface (X2-C/Xn-C). The X2-U/Xn-U may provide flow control mechanisms for user data packets transferred over the X2/Xn interface and may be used to communicate information about the delivery of user data between eNBs or gNBs. For example, the X2-U/Xn-U may provide specific sequence number information for user data transferred from a master eNB (MeNB) to a secondary eNB (SeNB); information about successful in sequence delivery of PDCP packet data units (PDUs) to a UE 1310 from an SeNB for user data; information of PDCP PDUs that were not delivered to a UE 1310; information about a current minimum desired buffer size at the SeNB for transmitting to the UE user data; and the like. The X2-C/Xn-C may provide intra-LTE access mobility functionality (e.g., including context transfers from source to target eNBs, user plane transport control, etc.), load management functionality, and inter-cell interference coordination functionality.

Alternatively, or additionally, RAN 1320 can be also connected (e.g., communicatively coupled) to CN 1330 via a Next Generation (NG) interface as interface 1324. The NG interface 1324 can be split into two parts, a Next Generation (NG) user plane (NG-U) interface 1326, which carries traffic data between the RAN nodes 1322 and a User Plane Function (UPF), and the S1 control plane (NG-C) interface 1328, which is a signaling interface between the RAN nodes 1322 and Access and Mobility Management Functions (AMFs).

CN 1330 can comprise a plurality of network elements 1332, which are configured to offer various data and telecommunications services to customers/subscribers (e.g., users of UEs 1310) who are connected to the CN 1330 via the RAN 1320. In some implementations, CN 1330 can include an evolved packet core (EPC), a 5G CN, and/or one or more additional or alternative types of CNs. The components of the CN 1330 can be implemented in one physical node or separate physical nodes including components to read and execute instructions from a machine-readable or computer-readable medium (e.g., a non-transitory machine-readable storage medium).

As shown, CN 1330, application servers 1340, and external networks 1350 can be connected to one another via interfaces 1334, 1336, and 1338, which can include IP network interfaces. Application servers 1340 can include one or more server devices or network elements (e.g., virtual network functions (VNFs) offering applications that use IP bearer resources with CN 1330 (e.g., universal mobile telecommunications system packet services (UMTS PS) domain, LTE PS data services, etc.). Application servers 1340 can also, or alternatively, be configured to support one or more communication services (e.g., voice over IP (VOIP sessions, push-to-talk (PTT) sessions, group communication sessions, social networking services, etc.) for UEs 1310 via the CN 1330. Similarly, external networks 1350 can include one or more of a variety of networks, including the Internet, thereby providing the mobile communication network and UEs 1310 of the network access to a variety of additional services, information, interconnectivity, and other network features.

In an aspect, the UEs 1310-1 and 1310-2 can operate to perform an IUC) for a SL communication by generating/transmitting or receiving/processing an IUC message that comprises at least one of: UE sensing results associated with directional sensing or beam alignment SL control channel/SL data channel transmission information for assisting in a resource selection. The SL communication can then be transmitted or received via the SL communication with the IUC message. The IUC message can be generated proactively the IUC message comprising at least one of: a set of preferred resources, or a set of non-preferred resources, to assist in a resource selection at the transmitting side of the SL communication. As such, the IUC message can be sent in response to receiving a request for IUC coordination information, or without receiving the request (e.g., based on SCI with reservation information or other trigger). Alternatively, or additionally, a reactive IUC scheme can be configured with the IUC message comprising conflicting resource information with resources associated with a receiving UE based on at least one of: reservation information associated with one or more transmitter/receiver UE pairs, receiving beams directed to the one or more transmitter/receiver UE pairs, or RSRP measurements of the receiving beams. The UE 1310-1 is configured to process, perform, generate, communicate or cause execution of any one or more combined further aspects described herein or in association with any of the FIGS. 1 thru 12.

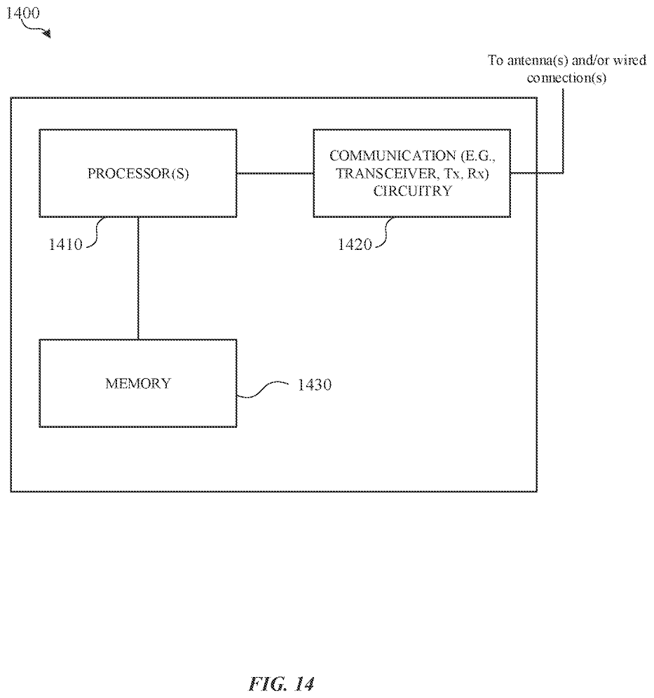

Referring to FIG. 14, illustrated is a block diagram of a UE device or other network component/device 1400 (e.g., V-UE/P-UE, IoT, gNB, eNB, base station or other participating network entity/component). The device 1400 includes one or more processors 1410 (e.g., one or more baseband processors) comprising processing circuitry and associated interface(s), transceiver circuitry 1420 (e.g., comprising RF circuitry, which can comprise transmitter circuitry (e.g., associated with one or more transmit chains) and/or receiver circuitry (e.g., associated with one or more receive chains) that can employ common circuit elements, distinct circuit elements, or a combination thereof), and a memory 1430 (which can comprise any of a variety of storage mediums and can store instructions and/or data associated with one or more of processor(s) 1410 or transceiver circuitry 1420).

Memory 1430 (as well as other memory components discussed herein, e.g., memory, data storage, or the like) can comprise one or more machine-readable medium/media including instructions that, when performed by a machine or component herein cause the machine or other device to perform acts of a method, an apparatus or system for communication using multiple communication technologies according to aspects, embodiments and examples described herein. It is to be understood that aspects described herein can be implemented by hardware, software, firmware, or any combination thereof. When implemented in software, functions can be stored on or transmitted over as one or more instructions or code on a computer-readable medium (e.g., the memory described herein or other storage device). Computer-readable media includes both computer storage media and communication media including any medium that facilitates transfer of a computer program from one place to another. A storage media or a computer readable storage device can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or other tangible and/or non-transitory medium, that can be used to carry or store desired information or executable instructions. Any connection can be also termed a computer-readable medium.

Memory 1430 can include executable instructions, and be integrated in, or communicatively coupled to, processor or processing circuitry 1410. The executable instructions of the memory 1430 can cause processing circuitry 1410 to generate a SL communication by performing an IUC for a SL communication by processing an IUC message comprising at least one of: receiving UE sensing results associated with directional sensing or beam alignment SL control channel/SL data channel transmission information. The SL communication can then be transmitted with the IUC message so that a transmitting UE can perform a resource selection procedure to determine SL resources for the SL communication based on the IUC or the IUC message.

The SL communication(s) can include an autonomous determination of the SL resources as a Mode 2 SL communication for FR2 or a frequency range 2. The IUC message can include information related to a receiving UE transmission mode to determine whether a receiver UE of the receiving UE sensing results is in a transmission mode or a receiving mode for receiving the SL communication. The beam alignment SL control channel/SL data channel transmission information of the IUC message comprises any SL resources or slots reserved by one or more other SL transmissions associated with the receiving UE in a transmitter/receiver UE pair. The receiving UE sensing results can comprise any slots that have a RSRP above or that satisfies an RSRP threshold for a receiving beam, and one or more slot indexes where receiving beams are directed to the UE.

A UE 1400 can receive or transmit in a proactive IUC scheme the IUC message comprising at least one of: a set of preferred resources, or a set of non-preferred resources, to assist in a resource selection, in response to a request for IUC coordination information, or without any request (e.g., based on an SCI or reservation information). The request can be multiplexed or piggybacked with a data transmission, and offset by a number of N slots from the request, wherein N can be an integer greater than zero. The device 1400 is configured to process, perform, generate, communicate or cause execution of any one or more combined aspects described herein or in association with any of the FIGS. 1 thru 13.

While the methods described within this disclosure are illustrated in and described herein as a series of acts or events, it will be appreciated that the illustrated ordering of such acts or events are not to be interpreted in a limiting sense. For example, some acts can occur in different orders and/or concurrently with other acts or events apart from those illustrated and/or described herein. In addition, not all illustrated acts can be required to implement one or more aspects or embodiments of the description herein. Further, one or more of the acts depicted herein can be carried out in one or more separate acts and/or phases. Reference can be made to the figures described above for ease of description. However, the methods are not limited to any particular embodiment, aspect or example provided within this disclosure and can be applied to any of the systems/devices/components disclosed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure is described with reference to attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can be also a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some embodiments, the circuitry can be implemented in, or functions associated with the circuitry can be implemented by, one or more software or firmware modules. In some embodiments, circuitry can include logic, at least partially operable in hardware.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units.

Examples (embodiments) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to embodiments and examples described herein.

A first example is a User Equipment (UE) comprising: processing circuitry, comprising at least one memory, configured to execute instructions cause the UE to: perform an inter-UE coordination (IUC) for a sidelink (SL) communication by processing an IUC message comprising at least one of: receiving UE sensing results associated with directional sensing or beam alignment SL control channel/sidelink data channel transmission information; and transmit the SL communication.

A second example can include the first example, wherein the processing circuitry is further configured to: perform a resource selection procedure to determine SL resources for the SL communication based on the IUC, wherein the SL communication comprises an autonomous determination of the SL resources as a Mode 2 SL communication for frequency range 2 (FR2).

A third example can include the first or second example, wherein the IUC message further comprises information related to a receiving UE transmission mode to determine whether a receiver UE of the receiving UE sensing results is in a transmission mode or a receiving mode for receiving the SL communication.

A fourth example can include any one or more of the first through third examples, wherein the beam alignment SL control channel/sidelink data channel transmission information of the IUC message comprises any SL resources or slots reserved by one or more other SL transmissions associated with the receiving UE in a transmitter/receiver UE pair.

A fifth example can include any one or more of the first through fourth examples, wherein the receiving UE sensing results comprise any slots that have a reference signal received power (RSRP) above an RSRP threshold for a receiving beam, and the IUC message further includes one or more slot indexes where receiving beams are directed to the UE.

A sixth example can include any one or more of the first through fifth examples, wherein the processing circuitry is further configured to: receive or transmit in a proactive IUC scheme the IUC message comprising at least one of: a set of preferred resources, or a set of non-preferred resources, to assist in a resource selection, in response to a request for IUC coordination information, or without any request.

A seventh example can include any one or more of the first through sixth examples, wherein the request is multiplexed or piggybacked with a data transmission, and wherein the IUC message is offset by a number of N slots from the request.

An eighth example can include any one or more of the first through seventh examples, wherein the set of preferred resources and the set of non-preferred resources include one or more slot indices associated with receiving beams directed to the UE or a transmitting UE, and are based on at least one of: receiving UE sensing results that include any reserved slots by any other SL transmission or any slots with a reference signal received power (RSRP) above an RSRP threshold associated with a receiving beam.

A ninth example can include any one or more of the first through eighth examples, wherein the IUC message is in at least one of: an IUC medium access control (MAC) control element (MAC CE) or a sidelink control information (SCI) stage 2, and the IUC message is received or transmitted over a reservation period based on one or more resource periodicities.

A tenth example can include any one or more of the first through ninth examples, wherein the processing circuitry is further configured to: receive or transmit in a reactive IUC scheme the IUC message further comprising conflicting resource information with resources associated with a receiving UE based on at least one of: reservation information associated with one or more transmitter/receiver UE pairs, receiving beams directed to the one or more transmitter/receiver UE pairs, or RSRP measurements of the receiving beams.

An eleventh example can include any one or more of the first through tenth examples, wherein, in response to being associated with a plurality of transmitter/receiver UE pairs with the UE on a same beam resource, the IUC message indicates resources based on an RSRP threshold and traffic priorities or delay budgets of the plurality of transmitter/receiver UE pairs, and wherein, in response to the plurality of transmitter/receiver UE pairs associated with a same priority, a receiver/transmitter UE pair with a higher RSRP among the plurality of transmitter/receiver UE pairs is prioritized for the resources or the IUC message indicates a round-robin allocation of the resources for the SL communication among the plurality of transmitter/receiver UE pairs.

A twelfth example can be a method of a user equipment (UE) comprising: performing an inter-UE coordination (IUC) for a sidelink (SL) communication by processing an IUC message comprising at least one of: receiving UE sensing results associated with directional sensing or beam alignment SL control channel/sidelink data channel transmission information; and transmitting the SL communication based on SL resources selected by the IUC.

A thirteenth example can include the twelfth example, further comprising: receiving or transmitting in a proactive IUC scheme the IUC message comprising at least one of: a set of preferred resources, or a set of non-preferred resources, to assist in a resource selection, in response to a request for IUC coordination information, or without any request.

A fourteenth example can include any one or more of the twelfth through the thirteenth examples, further comprising: coordinating different SL communications among different unicast transmitter/receiver UE pairs by generating a preferred resource/non-preferred resource slot pattern among the different unicast transmitter/receiver UE pairs.

A fifteenth example can include any one or more of the twelfth through the fourteenth examples, further comprising: in response to being communicatively coupled with a plurality of SL transmitter/receiver UE pairs via different receiver beams conflicting, respectively, the IUC message indicates resources for a SL transmitter/receiver UE pair based on a traffic priority, a UE priority or a round-robin allocation of the resources for the SL communication among the plurality of transmitter/receiver UE pairs.

A sixteenth example can include any one or more of the twelfth through the fifteenth examples, further comprising: processing the IUC message in a physical sidelink feedback channel (PSFCH) that is mapped through a sidelink control information (SCI); and in response to different beams being associated with different SL transmitter/receiver UE pairs, transmitting the PSFCH with the IUC message through the different beams in different slots, wherein an index of PSFCH resources is based on a physical SL shared channel transmission slot.

A seventeenth example can be a baseband processor of a user equipment (UE) configured to: perform an inter-UE coordination (IUC) for a sidelink (SL) communication by generating an IUC message comprising at least one of: UE sensing results associated with directional sensing or beam alignment SL control channel/sidelink data channel transmission information for assisting in a resource selection; and transmit the SL communication with the IUC message.

An eighteenth example can include the seventeenth example, further configured to: transmit proactively the IUC message comprising at least one of: a set of preferred resources, or a set of non-preferred resources, to assist in a resource selection, in response to receiving a request for IUC coordination information, or without receiving the request.

A nineteenth example can include any one or more of the seventeenth through eighteenth examples, wherein the set of preferred resources include one or more slot indices associated with receiving beams directed to a transmitting UE of the SL communication, and the non-preferred resources include any reserved slots by any other SL transmissions being received by other UEs and any slots with a reference signal received power (RSRP) above an RSRP threshold associated with one or more receiving beams directed toward the transmitting UE.

A twentieth example can include any one or more of the seventeenth through nineteenth examples, further configured to: transmit in a reactive IUC scheme the IUC message further comprising conflicting resource information with resources associated with a receiving UE based on at least one of: reservation information associated with one or more transmitter/receiver UE pairs, receiving beams directed to the one or more transmitter/receiver UE pairs, or RSRP measurements of the receiving beams.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communications media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the processes and/or actions of a method or algorithm can reside as one or any combination or set of codes and/or instructions on a machine-readable medium and/or computer readable medium, which can be incorporated into a computer program product.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

1. A User Equipment (UE) comprising:
radio frequency (RF) circuitry; and
processing circuitry configured to execute instructions stored in a memory to cause the UE to:
receive an inter-UE coordination (IUC) message comprising at least one of: directional sensing results from a receiving UE or beam alignment sidelink (SL) channel transmission information; and
transmit, via the RF circuitry, a SL communication based on the IUC message.

2. The UE of claim 1, wherein the processing circuitry is further causes the UE to:
perform a resource selection procedure to determine SL resources for the SL communication based on the IUC message, wherein the SL communication comprises an autonomous determination of the SL resources as a Mode 2 SL communication for frequency range 2 (FR2).

3. The UE of claim 1, wherein the IUC message further comprises information related to a transmission mode of the receiving UE, and wherein the processing circuitry further causes the UE to:
determine whether the receiver UE is in at transmission mode or a receiving mode for receiving the SL communication.

4. The UE of claim 1, wherein the beam alignment SL channel transmission information of the IUC message comprises any SL resources or slots reserved by one or more other SL transmissions associated with the receiving UE in a transmitter/receiver UE pair.

5. The UE of claim 1, wherein the directional sensing results from the receiving UE comprise any slots that have a reference signal received power (RSRP) above an RSRP threshold for a receiving beam, and the IUC message further includes one or more slot indices where receiving beams are directed to the UE.

6. The UE of claim 1, wherein the processing circuitry further causes the UE to:
receive, in a proactive IUC scheme, the IUC message further comprising at least one of: a set of preferred resources to assist in a resource selection, or a set of non-preferred resources to assist in the resource selection;
wherein the IUC message is received in response to a request for IUC coordination information, or without any request for IUC coordination information.

7. The UE of claim 6, wherein the request for IUC coordination information is multiplexed or piggybacked with a SL data transmission, and wherein the IUC message is offset by a number of N slots from the request.

8. The UE of claim 6, wherein the set of preferred resources and the set of non-preferred resources include one or more slot indices associated with receiving beams directed to the UE or a transmitting UE, and are based on at least one of: sensing results from the receiving UE that indicate slots reserved for other SL transmissions or slots with a reference signal received power (RSRP) above an RSRP threshold associated with a receiving beam.

9. The UE of claim 1, wherein the IUC message is included in at least one of: a medium access control (MAC) control element (MAC CE) or a stage 2 sidelink control information (SCI), and wherein the IUC message is received over a reservation period based on one or more resource periodicities.

10. The UE of claim 1, wherein the processing circuitry further causes the UE to:
transmit sidelink control information (SCI) to reserve a resource for the SL communication; and
receive, in a reactive IUC scheme, the IUC message further comprising an indication of a resource conflict with the reserved resource for the SL communication, wherein the indication is based on at least one of: reservation information associated with one or more transmitter/receiver UE pairs, receiving beams directed to the one or more transmitter/receiver UE pairs, or reference signal received power (RSRP) measurements of the receiving beams.

11. The UE of claim 1, wherein, in response to the UE being associated with a plurality of transmitter/receiver UE pairs, the IUC message indicates resources for the SL communication based on an RSRP threshold and traffic priorities or delay budgets of the plurality of transmitter/receiver UE pairs; and
wherein, in response to the plurality of transmitter/receiver UE pairs being associated with a same priority:
a transmitter/receiver UE pair with a higher RSRP among the plurality of transmitter/receiver UE pairs is prioritized for the resources for the SL communication; or
the IUC message indicates a round-robin allocation of the resources for the SL communication among the plurality of transmitter/receiver UE pairs.

12. A method of a user equipment (UE) comprising:
receiving an inter-UE coordination (IUC) message comprising at least one of: directional sensing results from a receiving UE or beam alignment sidelink (SL) channel transmission information; and
transmitting a SL communication based on the IUC message.

13. The method of claim 12, further comprising:
receiving, in a proactive IUC scheme, the IUC message comprising at least one of: a set of preferred resources to assist in a resource selection, or a set of non-preferred resources to assist in the resource selection;
wherein the IUC message is received in response to a request for IUC coordination information, or without any request for IUC coordination information.

14. The method of claim 12, further comprising:
coordinating different SL communications among different unicast transmitter/receiver UE pairs associated with the UE by generating a preferred resource/non-preferred resource slot pattern among the different unicast transmitter/receiver UE pairs.

15. The method of claim 12, further comprising:
in response to the UE being communicatively coupled with a plurality of transmitter/receiver UE pairs via conflicting receiver beams, the IUC message indicates resources for a transmitter/receiver UE pair based on a traffic priority, a UE priority, or a round-robin allocation of the resources for the SL communication among the plurality of transmitter/receiver UE pairs.

16. The method of claim 12, further comprising:
receiving the IUC message on a physical sidelink feedback channel (PSFCH) that is mapped through sidelink control information (SCI); and
in response to different beams being associated with different SL transmitter/receiver UE pairs, transmitting the PSFCH with the IUC message through the different beams in different slots,
wherein an index of PSFCH resources is based on a physical SL sidelink shared channel (PSSCH) transmission slot.

17. A baseband processor configured to, when executing instructions stored in a memory, perform operations comprising:
generating an inter-UE coordination (IUC) message comprising at least one of: directional sensing results or beam alignment sidelink (SL) channel transmission information for assisting in a resource selection; and
providing, to a radio frequency (RF) interface for transmission by RF circuitry, the IUC message;
receiving a SL communication based on the IUC message.

18. The baseband processor of claim 17, the operations further comprising:
generating, in a proactive IUC scheme, the IUC message comprising at least one of: a set of preferred resources to assist in a resource selection, or a set of non-preferred resources to assist in the resource selection;
wherein the IUC is message is generated in response to receiving a request for IUC coordination information, or without receiving the request for IUC coordination information.

19. The baseband processor of claim 18, wherein the set of preferred resources include one or more slot indices associated with receiving beams directed to a transmitting UE of the SL communication, and wherein the set of non-preferred resources include slots reserved for other SL transmissions being received by other UEs and slots with a reference signal received power (RSRP) above an RSRP threshold associated with one or more receiving beams directed toward the transmitting UE.

20. The baseband processor of claim 17, the operations further comprising:
receiving sidelink control information (SCI) to reserve a resource for the SL communication; and
generating, in a reactive IUC scheme, the IUC message further comprising an indication of a resource conflict with the reserved resource for the SL communication, wherein the indication is based on at least one of: reservation information associated with one or more transmitter/receiver UE pairs, receiving beams directed to the one or more transmitter/receiver UE pairs, or reference signal received power (RSRP) measurements of the receiving beams.
